(19) United States
(12) Patent Application Publication
(10) Pub. No.: US 2022/0104117 A1
(43) Pub. Date: Mar. 31, 2022

(54) NETWORK SELECTION METHOD AND DEVICE, AND STORAGE MEDIUM

(71) Applicant: GUANGDONG OPPO MOBILE TELECOMMUNICATIONS CORP. LTD., Dongguan (CN)

(72) Inventors: Yang Xu, Dongguan (CN); Jianhua Liu, Dongguan (CN)

(73) Assignee: GUANGDONG OPPO MOBILE TELECOMMUNICATIONS CORP., LTD., Dongguan (CN)

(21) Appl. No.: 17/547,534

(22) Filed: Dec. 10, 2021

Related U.S. Application Data
(63) Continuation of application No. PCT/CN2019/092416, filed on Jun. 21, 2019.

(51) Int. Cl. H04W 48/18; H04W 60/00

(52) U.S. Cl. CPC H04W 48/18; H04W 60/00

(57) ABSTRACT

A network selection method, including: receiving, by a terminal device, a network selection policy, where the network selection policy includes a correspondence relationship between an application and a public land mobile network (PLMN); and performing, by the terminal device, at least one of the following operations according to the network selection policy: selecting a PLMN for binding to an application, deciding whether to permit data of an application to be transmitted on a registered PLMN of the terminal device, and selecting a PLMN for registering. Another network selection method and device, and storage medium are also disclosed.

### CROSS-REFERENCE TO RELATED APPLICATION

The present application is a continuation of International Application No. PCT/CN2019/092416 filed on Jun. 21, 2019, the content of which is incorporated herein by reference in its entirety.

### TECHNICAL FIELD

The present disclosure relates to the technical field of wireless communication, and particularly to a network selection method and device, and storage medium.

### BACKGROUND

With the popularity of multiple subscriber identification module (SIM) cards or embedded-SIM (eSIM) cards, it will become possible for a terminal device to simultaneously access multiple public land mobile networks (PLMN), and for the terminal device to flexibly access multiple PLMNs. Therefore, it is necessary to clarify that the terminal device may select a PLMN network for registering based on applications, or whether data of applications may be permitted to be transmitted on a registered PLMN.

### SUMMARY

In order to solve the above technical problems, embodiments of the present disclosure provide a network selection method and device, and storage medium, which clarifies that a terminal device selects a PLMN network for registering and decides whether to permit date of an application to be transmitted on a registered PLMN based on a network selection policy including a correspondence relationship between an application and a PLMN.

In a first aspect, an embodiment or the present disclosure provides a network selection method, including: receiving, by a terminal device, a network selection policy, where the network selection policy includes a correspondence relationship between an application and a PLMN; performing, by the terminal device, at least one of the following operations according to the network selection policy: selecting a PLMN for binding to an application, deciding whether to permit data of an application to be transmitted on a registered PLMN of the terminal device, and selecting a PLMN for registering.

In a second aspect, an embodiment of the present disclosure provides a network selection method, including: acquiring, by a terminal device, a binding policy between an application and a universal subscriber identity module (USIM); binding, by the terminal device, different applications to different USIMs based on the binding policy between the application and the USIM.

In a third aspect, an embodiment of the present disclosure provides a network selection method, including: sending, by a network device, a network selection policy and/or a binding policy between an application and a USIM to a terminal device; where the network selection policy includes a correspondence relationship between an application and a PLMN, and is used by the terminal device to perform at least one of the following operations: selecting a PLMN for binding to an application, deciding whether to allow data of an application to be transmitted on a registered PLMN of the terminal device, and selecting a PLMN for registering.

In a fourth aspect, an embodiment of the present disclosure provides a terminal device, and the terminal device includes:

a receiving unit, configured to receive a network selection policy, where the network selection policy includes a correspondence relationship between an application and a PLMN;

a first processing unit, configured to perform at least one of the following operations according to the network selection policy: selecting a PLMN for binding to an application, deciding whether to permit data of an application to be transmitted on a registered PLMN of the terminal device, and selecting a PLMN for registering.

In a fifth aspect, an embodiment of the present disclosure provides a terminal device, including: an acquiring unit, configured to acquire a binding policy between an application and a USIM:

a second processing unit, configured to bind different applications to different USIMs based on the binding policy between the application and the USIM.

In a sixth aspect, an embodiment of the present disclosure provides a network device, and the network device includes:

a sending unit, configured to send a network selection policy and/or a binding policy between an application and a USIM to a terminal device where the network selection policy includes a correspondence relationship between an application and a PLMN, and is used by the terminal device to perform at least one of the following operations: selecting a PLMN for binding to an application, decides whether to permit data of an application to be transmitted on a registered PLMN of the terminal device, and selecting a PLMN for registering.

In a seventh aspect, an embodiment of the present disclosure provides a terminal device, including a processor and a memory for storing a computer program being executable on the processor, where the processor, when executing the computer program, is configured to perform steps of the above network selection method performed by the terminal device.

In an eighth aspect, an embodiment of the present disclosure provides a network device, including a processor and a memory for storing, a computer program being executable on the processor, where the processor, when executing the computer program, is configured to perform steps of the above network selection method performed by the network device.

In a ninth aspect, an embodiment of the present disclosure provides a storage medium storing an executable program, where when the executable program is executed by a processor, the above network selection method performed by the terminal device is implemented.

In a tenth aspect, an embodiment of the present disclosure provides a storage medium storing an executable program, where when the executable program is executed by a processor, the above network selection method performed by the network device is implemented.

The network selection method provided by an embodiment of the present disclosure includes: receiving, by a terminal device, a network selection policy, where the network selection policy includes a correspondence relationship between an application and a PLMN; performing, by the terminal device, at least one of the following operations according to the network selection policy: selecting a PLMN for binding to an application, deciding whether to permit data of an application to be transmitted on a registered PLMN of the terminal device, and selecting a PLMN for registering. In this way, it is clarified that the terminal device selects a PLMN network for binding to an application and decides whether to permit data of an application to be transmitted on a registered PLMN based on a network selection policy including a correspondence relationship between an application and a PLMN.

### BRIEF DESCRIPTION OF DRAWINGS

FIG. 1 is a schematic diagram of a composition structure of a communication system according to an embodiment of the present disclosure;

FIG. 2 is a schematic diagram of an processing flow of a network selection method applied to a terminal device provided by an embodiment of the present disclosure;

FIG. 3 is a schematic diagram of a processing flow of a terminal device receiving a network selection policy sent by a network device according to an embodiment of the present disclosure;

FIG. 4 is a schematic diagram of a registering flow of a terminal device of the present disclosure;

FIG. 5 is a schematic diagram of a correspondence relationship between an application and a PLMN according to an embodiment of the present disclosure;

FIG. 6 is a schematic diagram of another correspondence relationship between an application and a PLMN according to an embodiment of the present disclosure;

FIG. 7 is a schematic diagram of yet another correspondence relationship between an application and a PLMN according to an embodiment of the present disclosure;

FIG. 8 is a schematic diagram of relationships between applications and bound USIMs according to an embodiment of the present disclosure;

FIG. 9 is a schematic diagram of a terminal device establishing a connection relationship with only one USIM according to an embodiment of the present disclosure;

FIG. 10 is a schematic diagram of a terminal device deciding, according to a selected PLMN, whether to allow an application to perform data transmission according to an embodiment of the present disclosure;

FIG. 11 is a schematic diagram of another processing flow of a network selection method applied to a terminal device provided by an embodiment of the present disclosure;

FIG. 12 is a schematic diagram of a processing flow of a network selection method applied to a network device provided by an embodiment of the present disclosure;

FIG. 13 is a schematic diagram of a composition structure of a terminal device according to an embodiment of the present disclosure;

FIG. 14 is a schematic diagram of a composition structure of another terminal device according to an embodiment of the present disclosure;

FIG. 15 is a schematic diagram of a composition structure of a network device according to an embodiment of the present disclosure; and

FIG. 16 is a schematic diagram of a hardware composition structure of an electronic device according to an embodiment of the present disclosure.

### DESCRIPTION OF EMBODIMENTS

In order to have a more detailed understanding of features and technical content of embodiments of the present disclosure, implementations of the embodiments of the present disclosure are described in detail below in conjunction with drawings, the appended drawings are for illustration only, and are not used to limit the embodiments of the present disclosure.

Before the network selection methods provided by the embodiments of the present disclosure are illustrated in detail, a brief illustration of network selection processes in related technologies is made.

In a long term evolution (LTE) system, network selection policies for a terminal device mainly include: 1) inter-system mobility policy (IMSP); that is, the IMSP is used by a terminal device to select prior radio access technology (RAT) to route data packets, if a core network is connected simultaneously to two kinds of RATs, i.e. both the LTE and a WLAN, the terminal device can select, through the IMSP, which kind of the RATs is used to perform transmission of the data packets. 2) Access network discovery information; that is, a network device sends a series of information of access networks around a terminal device to the terminal device, the information of the access network includes: a access technology type, a radio access network identifier (e.g., a SSID of a WLAN), other detail information (e.g., one or more carrier frequencies), and a validity condition. 3) Inter-system routing policy (ISRP); a terminal device transmits, according to the ISRP policy, data packets through one or more radio access interfaces (e.g., transmits the data packets through multiple RATs) simultaneously. 4) Inter-APN routing policy (IARP); a terminal device determines, according to the IARP policy, which data flows need to be transmitted through different PDN connections, and which data flows need to be distributed through a WLAN; meanwhile, for the PDN connection transmission, a PDN connection corresponding to a specific APN may be selected based on the IARP. 5) WLAN selection policy (WLANSP); a terminal device selects, according to the WLANSP policy, a specific WLAN access point (SSID), which may include the following: a validity condition, including a time, a geographic location, a network location (e.g., PLMN, location area); the priority order of one or more WLAN selection criteria groups, each group includes one or more selection criteria that should be fulfilled by a WLAN access network in order to be selected. The selection criteria includes: a) WLAN attributes: e.g., a roaming partner list (Preferred Roaming List), a minimum backhaul threshold, a maximum base station subsystem load (Maximum BSS load), a required protocol port tuple (Required Proto Port Tuple), a list of SSIDs as defined in a SP exclusion list. b) Additional attributes, e.g., a preferred selected SSID list.

In a new radio (NR) system, network selection policies for a terminal device includes: URSP (UE Routing Selection Policy) policy. Related content of the URSP policy is shown in table 1 below; and related description of route selection is shown in table 2 below.

TABLE 1

| | | | PCT | |
|---|---|---|---|---|
| | | | permitted | |
| Information | | | to modify in | |
| name | Description | Category | a UE context | Scope |
| Ride | Determines the | Mandatory | Yes | UE |
| precedence | order the URSP | | | context |
| | rule is enforced in | | | |
| | the UE | | | |
| Traffic | This part defines | | | |
| descriptor | the traffic | | | |
| | descriptors for the | | | |
| | policy | | | |
| Application | Application | Optional | Yes | UE |
| identifiers | identifier(s) | | | context |
| Internet | IP 3 tuple(s) | Optional | Yes | UE |
| protocol (IP) | (destination IP | | | context |
| descriptors | address or IPv6 | | | |
| | network prefix, | | | |
| | destination port | | | |
| | number, protocol | | | |
| | ID of the protocol | | | |
| | above IP) | | | |
| Non-IP | Descriptor(s) for | Optional | Yes | UE |
| descriptors | non-IP traffic | | | context |
| List of RSDs | A list of Route | Mandatory | | |
| | Selection | | | |
| | Descriptors | | | |

NOTE 1:
Rules in a URSP shall have different precedence values.

TABLE 2

| | | | PCF | |
|---|---|---|---|---|
| | | | permitted | |
| Information | | | to modify in | |
| name | Description | Category | a UE context | Scope |
| RSD | Determines the | Mandatory | Yes | UE |
| precedence | order in which the | | | context |
| | Route Selection | | | |
| | Descriptors are to | | | |
| | be applied | | | |
| Route | This part defines | Mandatory | | |
| selection | the route selection | | | |
| components | components | | | |
| SSC mode | One single value | Optional | Yes | UE |
| selection | of SSC mode | | | context |
| Network slice | Either one single | Optional | Yes | UE |
| selection | value or a list of | | | context |
| | values of S- | | | |
| | NSSAI(s) | | | |
| DNN selection | Either one single | Optional | Yes | UE |
| | value or a list of | | | context |
| | values of DNN(s) | | | |
| Non-seamless | Indicates if the | Optional | Yes | UE |
| offload | traffic of the | | | context |
| indication | matching | | | |
| | application is to be | | | |
| | offloaded to non- | | | |
| | 3^{rd} Generation | | | |
| | Partnership Project | | | |
| | access outside of a | | | |
| | PDU session | | | |
| Access type | Indicates the | Optional | Yes | UE |
| preference | preferred access | | | context |
| | type (3GPP or | | | |
| | non-3GPP) when | | | |
| | the UE establishes | | | |
| | a PDU session for | | | |
| | the matching | | | |
| | application | | | |

NOTE 1:
Every Route Selection Descriptor in the list shall have a different precedence value.
NOTE 2:
At least one of the route selection components shall be present.
NOTE 3:
If this indication is present in a Route Selection Descriptor, no other components shall be included in the Route Selection Descriptor.

For the URSP policy in the NR system, a terminal device associates an application with a corresponding PDU session for transmitting based on the URSP policy; in a specific implementation, when data appears at an application layer, the terminal device uses a URSP rule in the URSP policy to check whether a feature of the application data matches a Traffic Descriptor of a certain rule in the URSP rules shown in table 1, the order of checking is determined according to the precedence in the Traffic Descriptor in the URSP rules; that is, the terminal device sequentially checks matching statuses based on an order of the precedence, when one URSP rule is matched, a list of RSD under the URSP rule is used for binding a protocol data unit (PDU) session. Specifically, when a URSP rule is matched, a UE searches for a suitable PDU session according to an order of the precedence in the list of RSD, for example, preferentially RSD with a high precedence is used; if a certain parameter in the list of RSD with a high precedence is one or more values, then the terminal device selects one of the parameters, combined together with other parameters, to search for whether a PDU session exists; if it exists, then the application data is bound to the PDU session for transmitting; if it does not exist, then the terminal device triggers an establishment of the PDU session, and the terminal device reports attribute parameters of the PDU session in an establishment request message; if the PDU session is established successfully, then the terminal device binds the application data to the PDU session for transmitting; if the PDU session is not established successfully, then the terminal device searches again for whether a PDU session exists based on other-parameter combinations in the list of RSD or by using parameter combinations in a list of RSD with a secondary precedence; if no suitable PDU session can be found for binding according to the matched URSP rule, then the terminal device searches for whether a Traffic Descriptor in a URSP rule with a secondary precedence may match the feature of the application data flow according to the order of the precedence; when they are matched, the process previously described are repeated.

The above process of seeking a suitable PDU session for an application is called “evaluation”. After a suitable PDU session is sought for binding, the terminal device will re-perform the evaluation under the following situations to check whether a binding relationship between the original application data and the PDU session needs to be changed: the URSP policy is updated by the PCF (the URSP is updated by the PCF), the terminal device moves from EPC to 5GC (the UE moves from EPC to 5GC), allowed or configured network slice selection assistance information Changes (change of Allowed NSSAI or Configured NSSAI), LADN DNN availability changes (change of LADN DNN availability), terminal device registers over 3GPP or non-3GPP access (UE registers over 3GPP or non-3GPP access), and terminal device establishes connection to a WLAN access (UE established connection to a WLAN access).

In the NR and LTE systems, the network selection policies for a terminal device also includes: selecting a network based on a PLMN of the terminal device or an access technology. In a specific implementation, the terminal device selects a PLMN based on information stored in a SIM card or a ME; the information includes: “HPLMN Selector with Access Technology”, “User Controlled PLMN Selector with Access Technology”, “Forbidden PLMNs”, and “Equivalent HPLMN”. Where for “HPLMN Selector with Access Technology” and “User Controlled PLMN Selector with Access Technology”, selection of the PLMN and selection of the access technology are performed by the terminal device; the specific selection policy is shown in table 3 below, priority of different PLMNs and access type of a permitted access under each PLMN may be defined. For “Forbidden PLMNs”, the terminal device will not initiate a registration to the Forbidden PLMNs; of course, for special services (such as an emergency call service), the terminal device can initiate a registration to the Forbidden PLMNs. For “Equivalent HPLMN”, after the terminal device is registered to one PLMN, an access and mobility management function (AMF) entity on a network device side can send one PLMN list to the terminal device, and the PLMN list is used by the terminal device to perform a cell selection or a cell reselection under a CM-IDLE state. The terminal device takes all PLMNs in the PLMN list sent by the AMF entity as equivalent PLMNs, the Equivalent PLMN refers to that after the terminal device is registered in a current PLMN, when it is unable to connect to the PLMN at a subsequent certain time, other Equivalent PLMNs may be selected for accessing.

TABLE 3

| | | |
|---|---|---|
| Identifier: ‘6F60’ | Structure: transparent | Optional |

| SFI: ‘0A’ | |
|---|---|
| File size; 5n (where n ≥8 bytes) | Update activity: low |

Access conditions:
READ PIN
UPDATE PIN
DEACTIVE ADM
ACTIVE ADM

| Bytes | Description | M/O | Length |
|---|---|---|---|
| 1 to 3 | 1^{st} PLMN (highest priority) | M | 3 bytes |
| 4 to 5 | 1^{st} PLMN Access Technology identifier | M | 2 bytes |
| 6 to 8 | 2^{nd} PLMN | M | 3 bytes |
| 9 to 10 | 2^{nd} PLMN Access Technology Identifier | M | 2 bytes |
| . | . | | |
| . | . | | |
| . | . | | |
| 36 to 38 | 8^{th} PLMN | M | 3 bytes |
| 39 to 40 | 8^{th} PLMN Access Technology Identifier | M | 2 bytes |
| 41 to 43 | 9^{th} PLMN | O | 3 bytes |
| 44 to 45 | 9^{th} PLMN Access Technology Identifier | O | 2 bytes |
| . | . | | |
| . | . | | |
| . | . | | |
| (5n-4) to | N^{th} PLMN (lowest priority) | O | 3 bytes |
| (5n-2) | | O | |
| (5n-1) to | N^{th} PLMN Access Technology Identifier | | 2 bytes |
| 5n | | | |

In the NR system, a need for performing different transmission policies based on different applications is very clear; therefore, the applicant believes that selection of PLMN for registering based on applications also needs to be clarified.

Based on the above problems, the present disclosure provides a network selection method, the network selection method of embodiments of the present application may be applied to various communication systems, for example: a global system of mobile communication (GSM) system, a code division multiple access (CDMA) system, a wideband code division multiple access (WCDMA) system, a general packet radio service (GPRS) system, an LTE system, an LTE frequency division duplex (FDD) system, an LTE time division duplex (TDD) system, a universal mobile telecommunication system (UMTS), a worldwide interoperability for microwave access (WiMAX) communication system, or a 5G system, etc.

Exemplarily, a communication system 100 applied in an embodiment of the present application is shown in FIG. 1. The communication system 100 may include a network device 110, and the network device 110 may be a device that communicates with a terminal device 120 (or referred to as a communication terminal, a terminal). The network device 110 may provide a communicating coverage for a specific geographic area, and may communicate with a terminal device located in the coverage area. In an implementation, the network device 110 may be a base station (Base Transceiver Station, BTS) in a GSM system or a CDMA system, a base station (NodeB, NB) in a WCDMA system, or an evolutional base station (Evolutional NodeB, eNB or eNodeB) in an LTE system, or a radio controller in a cloud radio access network (CRAN), or the network device may be a mobile switching center, a relay station, an access point, a vehicle-mounted device, a wearable device, a hub, a switch, a network bridge, a router, a network side device in a 5G network, or a network device in a future evolutional public land mobile network (PLMN), etc.

The communication system 100 also includes at least one terminal device 120 located within the coverage range of the network device 110. The “terminal device” as used herein includes, but is not limited to, a device being connected through a wired line, for example, through a public switched telephone network (PSTN), a digital subscriber line (DSL), a digital cable and a direct cable, and/or a device being connected through another data connection/network, and/or a device being connected through a wireless interface, for example, for a cellular network, a wireless local area network (WLAN), a digital television network like a DVB-H network, a satellite network and an AM-FM broadcast transmitter, and/or an apparatus arranged to receive transmit a communication signal in another terminal device, and/or an interact of things (IoT) device. A terminal device arranged to communicate through a wireless interface may be referred to as a “wireless communication terminal”, a “wireless terminal” or a “mobile terminal”. Examples of a mobile terminal include, but are not limited to: a satellite or cellular telephone, a personal communication system (PCS) terminal capable of combining a cellular radio telephone and data processing, faxing and data communicating capabilities; a PDA capable of including a radio telephone, a pager, an internet/intranet access, a Web browser, a notepad, a calendar and/or a global positioning system (GPS) receiver; and a conventional laptop and/or palmtop receiver or other electronic apparatuses including a radio telephone transceiver. The terminal device may refer to an access terminal, a user equipment (UE), a user unit, a user station, a mobile station, a mobile platform, a remote station, a remote terminal, a mobile device, a user terminal, a terminal, a wireless communication device, a user agent or a user apparatus. The access terminal may be a cell phone, a cordless phone, a session initiation protocol (SIP) phone, a wireless local loop (WLL) station, a personal digital assistant (PDA), a handheld device with a wireless communication function, a computing device, other processing devices connected to a wireless modem, a vehicle-mounted device, a wearable device, a terminal device in a 5G network, or a terminal device in a future evolutional PLMN, etc.

In an implementation, a device to device (D2D) communication may be performed between the terminal devices 120.

In an implementation, the 5G system or the 5G network may also be referred to as a new radio (NR) system or a NR network.

FIG. 1 exemplarily shows one network device and two terminal devices, in an implementation, the communication system 100 may include multiple network devices and other number of terminal devices may be included within a coverage range of each network device, which is not limited in embodiments of the present application.

In an implementation, the communication system 100 may also include other network entities such as a network controller, a mobility management entity, etc., which is not limited in embodiments of the present application.

It should be understood that a device with a communication function in a network system in embodiments of the present application may be referred to as a communication device. Taking the communication system 100 shown in FIG. 1 as an example, the communication device may include a network device 110 with a communication function and a terminal device 120 with a communication function, and the network device 110 and the terminal device 120 may be the specific devices described above, which will not be repeated herein; the communication device may also include other devices in the communication system 100, for example, other network entities such as a network controller, a mobility management entity, etc., which is not limited in embodiments of the present application.

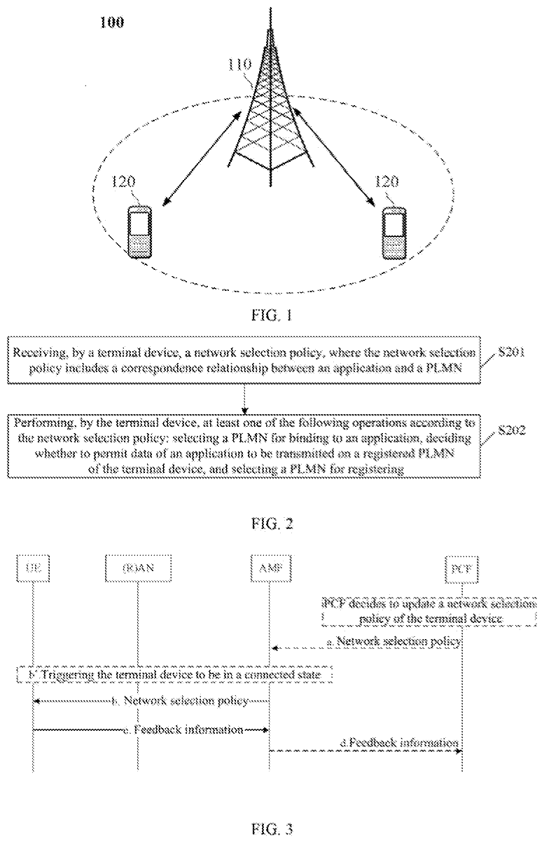

An processing flow of a network selection method applied to a terminal device provided by an embodiment of the present disclosure, as shown in FIG. 2, includes the following steps:

step S201: receiving, try a terminal device, a network selection policy, where the network selection policy includes a correspondence relationship between an application and a PLMN.

In an embodiment of the present disclosure, the terminal device receives the network selection policy sent by a network device. A schematic diagram of a processing flow of a terminal device receiving a network selection policy sent by a network device, as shown in FIG. 3, includes:

step a: transferring, by a PCF entity of a network device, a network selection policy to an AMP entity.

In some embodiments, the PCF entity decides to update a network selection policy of the terminal device, and transfers a network selection policy to the AMF entity through a container. Specifically, the PCF entity transfers the network selection policy to the AMF entity through a Namf_Communication_N1N2 Message,

Step b: transmitting, by the AMY entity, the network selection policy to the terminal device transparently.

In some embodiments, the AMF entity transmits the network selection policy to the terminal device transparently through a NAS message.

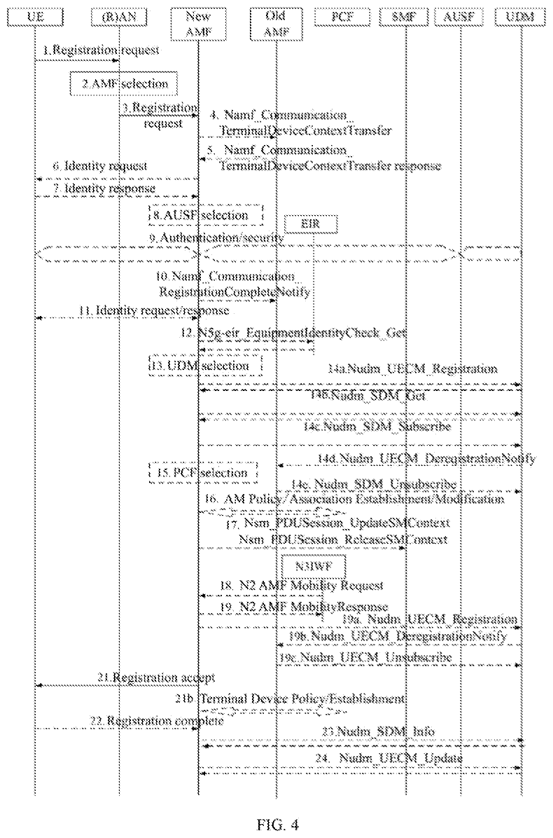

The NAS message may be a UE Configuration Update Command message; or, the NAS message is a service request reply message; or, the NAS message is a registration accept message involved in step 21 in a registering flow of a terminal device shown in FIG. 4, that is, the AMF entity sends the network selection policy to the terminal device by carrying the network selection policy in the Registration accept message.

It should be noted that if the terminal device is in an idle state, a step b′ needs to be performed before the step b is performed.

Step b′, triggering the terminal device to be in a connected state.

In some embodiments, an interaction of a network triggered service request is performed between the AMF entity and the terminal device, to trigger the terminal device to be in the connected state.

Step c: sending, by the terminal device, feedback information to the AMF entity.

In some embodiments, after the network selection policy is received, the terminal device sends feedback information to the AMF entity through a Namf_N1MessageNotify, and the feedback information is used to notify whether the network selection policy is transmitted to the terminal device successfully.

Step d: transmitting, by the AMF entity, the feedback in formation to the PCF entity transparently.

In some embodiments, the AMF entity transmits the received feedback information to the PCF entity transparently through the container.

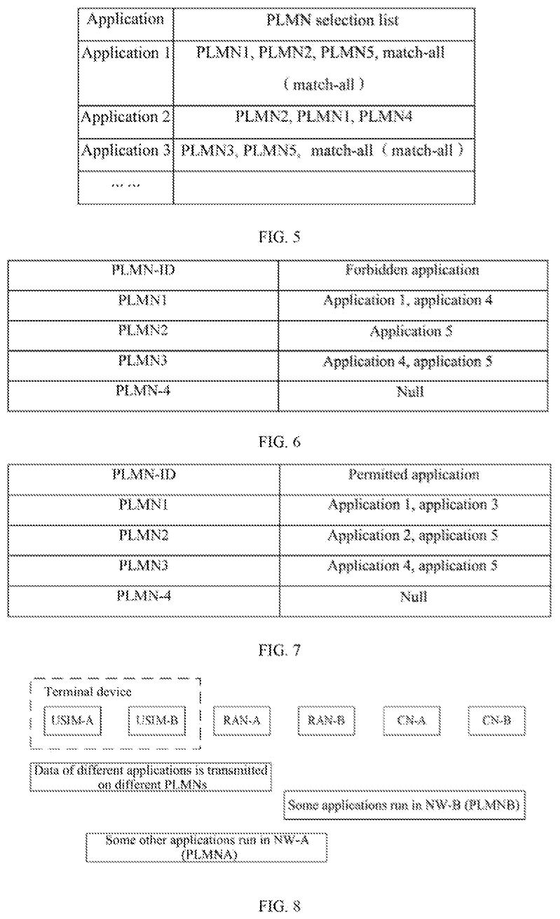

In an embodiment of the present disclosure, the network selection policy includes a correspondence relationship between an application and a PLMN; where the PLMN is a network established and operated for the purpose of providing land mobile communication services to the public, and the PLMN may be represented by a PLMN identifier (PLMN ID); the application may also be referred to as a service. In a specific implementation, one kind of correspondence relationship between an application and a PLMN, as shown in FIG. 5, is a correspondence relationship between an application and one or more available PLMNs; a PLMN selection list corresponding to an application 1 includes PLMN1, PLMN2, and PLMN5, which represents that data of the application 1 is permitted to be transmitted on the PLMN1, the PLMN2, and the PLMN5; a PLMN selection list corresponding to an application 2 includes PLMN2, PLMN1, and PLMN4, which represents that data of the application 2 is permitted to be transmitted on the PLMN2, the PLMN1, and the PLMN4; a PLMN selection list corresponding to an application 3 includes PLMN3 and PLMN5, which represents that data of the application 3 is permitted to be transmitted on the PLMN3 and the PLMN5, Another kind of correspondence relationship between an application and a PLMN, as shown in FIG. 6, is a correspondence relationship of at least one application forbidden to use under different PLMNs; applications forbidden under PLMN1 include an application 1 and an application 4, which represents that data of the application 1 and data of the application 4 are forbidden to be transmitted on the PLMN1; an application forbidden under PLMN2 includes an application 5, which represents that data of the application 5 is forbidden to be transmitted on the PLMN2; applications forbidden under PLMN3 include an application 4 and an application 5, which represents that data of the application 4 and data of the application 5 are forbidden to be transmitted on the PLMN3, an application forbidden under PLMN4 is null, which represents that data of all applications may be transmitted on the PLMN4. Yet another correspondence relationship between an application and a PLMN, as shown in FIG. 7, is a correspondence relationship of at least one application permitted to use under different PLMNs; application permitted under PLMN1 include an application 1 and an application 3, which represents that data of the application 1 and data of the application 3 may be transmitted on the PLMN1; applications permitted under PLMN2 include an application 2 and an application 5, which represents that data of the application 2 and data of the application 5 may be transmitted on the PLMN2; applications permitted under PLMN3 include an application 4 and an application 5, which represents that data Of the application 4 and data of the application 5 may be transmitted on the PLMN3. A correspondence relationship between an application and a PLMN may be represented by a correspondence relationship between an application identifier and a PLMN ID; where the application identifier may be identified by parameters such as an application ID, a source/destination IP address, a source destination media ace s control (MAC) address, a data network name (DNN), etc.

In some embodiments, under the circumstance that content of the network selection policy is the same as a forbidden PLMN, the forbidden PLMN is not selected for binding to the application. For example, if PLMNs corresponding to an application 1 include PLMN1, PLMN2, and PLMN5, and a Forbidden PLMN configured by the network device for the terminal device is the PLMN1, then the terminal device cannot use the PLMN1 for transmitting data of the application 1; the terminal device may only select one of the PLMN2 and the PLMN5 to transmit data of the application 1, Specifically, even if a priority of the PLMN1 is higher than that of the PLMN2 and the PLMN5, the terminal device still cannot select the PLMN1 for binding to the application 1. The binding a PLMN to an application refers to that data of the application may be transmitted on the PLMN.

In some other embodiments, when a PLMN corresponding to an application and being selected according to the network selection policy is an equivalent PLMN of a currently registered PLMN of the terminal device, the currently registered PLMN is selected. For example, if a selectable PLMN corresponding to an application 1 is PLMN1; and, the PLMN1 is an Equivalent PLMN of currently registered PLMN2 of the terminal device; then the terminal device selects to bind the application 1 to the PLMN2. The equivalent PLMN is used in a handover process such that a source network device may select one network device or cell belonging to another PLMN (which belongs to an equivalent PLMN of the PLMN of the network device) as a handover target (when the terminal device moves between cells or network devices of equivalent PLMNs, current context can be used continuously), and the equivalent PLMN may also be used by the terminal device to perform a cell selection or a cell reselection under a CM-IDLE state. The terminal device takes all PLMNs in a PLMN list sent by the AMF entity as equivalent PLMNs, the Equivalent PLMN refers to that after the terminal device is registered in a current PLMN, other Equivalent PLMNs may be selected for accessing, under some conditions (for example, when it is unable to connect to the PLMN at a subsequent certain time). After the terminal device is registered to one PLMN, a network device (e.g., the AMF) entity can send an equivalent PLMN list to the terminal device.

When content of the network selection policy is that a PLMN corresponding, to an application belongs to one PLMN within a registration area of the terminal device, and another PLMN within the registration area is a currently registered PLMN of the terminal device, the currently registered PLMN is selected. For example, alter the terminal device requests to register a network, a received registration reply message includes one registration area, and a tracking area identifier (TAI) list in the registration area includes multiple TAIs, and each TAI corresponds to one PLMN; a PLMN corresponding to a TAI in the TAI LIST is regarded as an “equivalent PLMN”. In a specific implementation, if a selectable PLMN corresponding to an application 1 is PLMN1 and, a TAI in the same registration area indicates PLMN-1 and PLMN-2, and the terminal currently registers or keeps a connection on a TAI corresponding to the PLMN-2 then, the terminal device binds the application 1 to the PLMN2.

Under the circumstance that the network selection policy includes correspondence relationships between an application and at least two PLMNs, the at least two PLMNs may not have a priority order. Then, the terminal device selects one PLMN of the at least two PLMNs for binding to the application, or selects one PLMN for registering.

In some embodiments, under the circumstance that none of PLMNs corresponding to an application is available, an available PLMN is selected for registering, or an available PLMN is selected for transmitting data corresponding to the application; where the available PLMN is a registered PLMN of the terminal device. In a specific implementation, in the correspondence relationship between an application and an PLMN shown in FIG. 5, if a PLMN selection list corresponding to an application includes “match-all”, then it represents that under the circumstance that none of PLMNs corresponding to the application is available, an available PLMN is selected for binding to the application, or an available PLMN is selected for transmitting data of the application. Accordingly, in the correspondence relationship between an application and a PLMN shown in FIG. 5, if a PLMN selection list corresponding to an application does not include “match-all”, then the terminal device can only select a PLMN in the PLMN selection list for binding to the application, or the terminal device can only select a PLMN in the PLMN selection list to transmit data of the application.

Related description of route selection, as shown in table 4 below, adds related description of a PLMN selection list on the basis of table 2.

TABLE 4

| | | | PCF | |
|---|---|---|---|---|
| | | | permitted | |
| Information | | | to modify in | |
| name | Description | Category | a UE context | Scope |
| RSD | Determines the | Mandatory | Yes | UE |
| precedence | order in which the | | | context |
| | Routing Selection | | | |
| | Descriptors are to | | | |
| | be applied | | | |
| Route | This part defines | Mandatory | | |
| selection | the route selection | | | |
| components | components | | | |
| SSC mode | One single value of | Optional | Yes | UE |
| selection | SSC mode | | | context |
| Network slice | Either one single | Optional | Yes | UE |
| selection | value or a list of | | | context |
| | values of S- | | | |
| | NSSAI(s) | | | |
| DNN selection | Either one single | Optional | Yes | UE |
| | value or a list of | | | context |
| | values of DNN(s) | | | |
| Non-seamless | Indicates if the | Optional | Yes | UE |
| Offload | traffic of the | | | context |
| indication | matching | | | |
| | application is to be | | | |
| | offloaded to non- | | | |
| | 3rd Generation | | | |
| | Partnership Project | | | |
| | access outside of a | | | |
| | PDU Session | | | |
| Access type | Indicates the | Optional | Yes | UE |
| preference | preferred access | | | context |
| | type when the UE | | | |
| | establishes a PDU | | | |
| | Session for the | | | |
| | matching | | | |
| | application | | | |
| PLMN | Indicates a | | | |
| selection list | PLMN network | | | |
| | that one or more | | | |
| | applications can | | | |
| | access | | | |

NOTE 1:
Every Route Selection Descriptor in the list shall have a different precedence value.
NOTE 2:
At least one of the route selection components shall be present.
NOTE 3:
If this indication is present in a Route Selection Descriptor, no other components shall be included in the Route Selection Descriptor.

In an embodiment of the present disclosure, the network selection policy includes multiple rules, and the multiple rules may have a priority order. When the network selection policy is the correspondence relationship between an application and at least one PLMN as shown in FIG. 5, then the correspondence relationship between one application and a PLNN selection list shown in each row of FIG. 5 is one rule; the terminal device evaluates which PLMN can be bound to the application. If the PLMN to which the terminal device can bind the application includes a currently registered PLMN, then data of the application can be transmitted on the currently registered PLMN. If the PLMN to which the application can bind does not include a currently registered PLMN of the terminal device, but the currently registered PLMN is an equivalent PLMN of a PLMN that can bind to the application, then data of the application can be transmitted on the currently registered PLMN. In addition, the terminal device can select one PLMN for accessing according to the network selection policy, to transmit data of the application. For example, for an important application, if there is no PLMN that can be bound according to the network selection policy, the terminal device can register to one new PLMN, and the new PLMN can bind to the application.

In some embodiments, a network selection policy, as shown in table 5 below, adds permitted applications, or forbidden applications on the basis of table 3; for example, “applications 1 and 2 are forbidden”, “only applications 2 and 3 are permitted”, and “all applications are permitted” in table 5.

TABLE 5

| | | |
|---|---|---|
| Identifier: ‘6F60’ | Structure: transparent | Optional |

| | |
|---|---|
| SFI: ‘0A’ | |
| File size: 5n (where n ≥8 bytes) | Update activity:low |

Access conditions:
READ PIN
UPDATE PIN
DEACTIVE ADM
ACTIVE ADM

| Bytes | Description | M/O | Length |
|---|---|---|---|
| 1 to 3 | 1^{st} PLMN (highest priority) | M | 3 bytes |
| 4 to 5 | 1^{st} PLMN Access technology identifier | M | 2 bytes |
| | Applications 1 and 2 are forbidden | | |
| 6 to 8 | 2^{nd} PLMN | M | 3 bytes |
| 9 to 10 | 2^{nd} PLMN Access technology identifier | M | 2 bytes |
| | Only applications 2 and 3 are permitted | | |
| . | . | | |
| . | . | | |
| . | . | | |
| 36 to 38 | 8^{th} PLMN | M | 3 bytes |
| 39 to 40 | 8^{th} PLMN Access technology identifier | M | 2 bytes |
| | All applications are permitted | | |
| 41 to 43 | 9^{th} PLMN | O | 3 bytes |
| 44 to 45 | 9^{th} PLMN Access technology identifier | O | 2 bytes |
| . | . | | |
| . | . | | |
| . | . | | |
| (5n-4) to | N^{th} PLMN (Lowest priority) | O | 3 bytes |
| (5n-2) | | | |
| (5n-1) to | N^{th} PLMN Access technology identifier | O | 2 bytes |
| 5n | | | |

Step S202, performing, by the terminal device, at least one of the following operations according to the network selection policy; selecting a PLMN for binding to an application, deciding whether to permit data of an application to be transmitted on a registered PLMN of the terminal device, and selecting a PLMN for registering.

In an embodiment of the present disclosure, after the terminal device is registered in a PLMN, the terminal device may be in a connected state, an idle state or an RRC-INACTIVE state, but context information of a belonging terminal device is present between the terminal device and the network, and the context information is such as security context, mobility management and access management context, session context, etc.; the terminal device may also select to reside in one cell under the PLMN, that is, it can receive a system broadcast and paging message of the cell as well as can initiate a radio resource control (RRC) connection establishment, but the terminal device has not yet initiated a registration request to or a RRC connection to the PLMN.

When the terminal device performs the network selection method of the above embodiment of the present disclosure, if the terminal device uses multiple USIMs, then the terminal device can bind different applications to different USIMs. It can be understood that the terminal device binds an application to a PLMN, and uses a PLMN registered by a certain USIM to transmit data of the application, that is, the terminal device can select networks registered by different USIMs for different applications to transmit date, and the terminal device can simultaneously register on multiple PLMNs. A schematic diagram of relationships between applications and bound USIMs is shown in FIG. 8, the terminal device performs data transmission of one kind of application by utilizing a network registered by USIM-A, and the terminal device performs data transmission of another kind of application by utilizing a network registered by USIM-B. In this way, by selecting transmission of applications based on different PLMNs, in case of multiple USIMs, it not only enables services to be completed according to user's needs, but also helps to improve service security, reliability and service distribution.

In some embodiments, in case of multiple USIMs, if the terminal device cannot perform data transmission while simultaneously connecting, to PLMNs corresponding to two USIMs (for example, under the circumstance that the terminal device supports only unidirectional data transmission and unidirectional data reception, or the terminal device supports only unidirectional data transmission and bidirectional data reception), the terminal device determines binding relationships between applications and USIMs according to PLMNs corresponding respectively to networks registered by multiple USIMs and the network selection policy.

Based on the above situation where the terminal device supports only unidirectional data transmission and unidirectional data reception, or the terminal device supports only unidirectional data transmission and bidirectional data reception, that is, the terminal device cannot perform data transmission while simultaneously connecting to PLMNs corresponding to two USIMs, even though the terminal device needs to perform data transmission of one kind of application by utilizing a network registered by USIM-A, and performs data transmission of another kind of application by utilizing a network registered by USIM-B. When the terminal is transmitting data of an application B by using a network connected by the USIM-B, the terminal needs to perform an application A that has a binding relationship with the USIM-A, and a priority of the application A is higher than that of the application B, and the terminal device needs to release a connection relationship with the USIM-B and establishes a connection with the USIM-A for data transmission; a schematic diagram of a terminal device establishing a connection relationship with only one USIM is shown in FIG. 9.

In some other embodiments, in case of multiple USIMs, if PLMNs corresponding to an application 1 are PLMN1 and PLMN2, USIM1 corresponds to the PLMN1, and USIM2 corresponds to the PLMN2; then, when the terminal device fails to bind the application 1 on the USIM1, the terminal device can bind the application 1 to the USIM2.

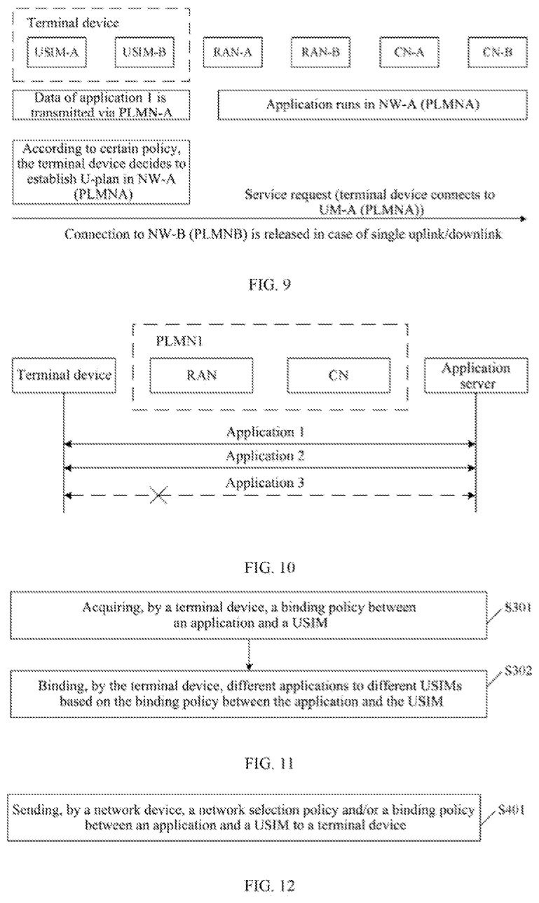

When the terminal device performs the network selection method of the above embodiment, of the present disclosure, if the terminal device uses a single USIM, the terminal device determines which application data may be transmitted on a currently registered PLMN or selects one PLMN for accessing based on the network selection policy and/or the available PLMN LIST sent by the network device and received by the terminal device. The terminal device may select one PLMN for registering according to at least one of a running application, an application expected to be performed by the terminal device, or an application supported by the terminal device itself. The terminal device decides whether to permit the application to transmit data according to a registered PLMN. For example, as shown in FIG. 10, the terminal device has registered on PLMN1, according to the network selection policy, it is determined that both application 1 and application 2 can access the PLMN 1, that is, data of the application 1 and the application 2 can be transmitted on the PLMN1, while an application 3 cannot access the PLMN1, that is, data of the application 3 cannot be transmitted on the PLMN1, then the terminal binds the application 1 and the application 2 to the PLMN1. The available PLMN LIST may be an equivalent PLMN LIST.

Another processing flow of a network selection method applied to a terminal device provided by an embodiment of the present disclosure, as shown in FIG. 11, includes:

step S301: acquiring, by a terminal device, a binding policy between an application and a USIM.

In an embodiment of the present disclosure, the terminal device acquires a binding policy between an application and a USIM by receiving the binding policy between the application and the USIM sent by a network device; or, the terminal device acquires a binding policy between an application and a USIM through a locally configured binding policy between an application and a USIM.

Step S302, binding, by the terminal device, different applications to different USIMs based on the binding policy between the application and the USIM.

In some embodiments, the terminal device determines binding relationships between applications and USIMs according to PLMNs corresponding respectively to networks registered by multiple USIMs and a network selection policy;

In an embodiment of the present disclosure, the network selection policy includes a correspondence relationship between an application and a PLMN; description for the network selection policy is the same as that in the above step S201, and will not be repeated herein.

After step S302 is performed, the method further includes:

determining, by the terminal device, whether to permit data of application to be transmitted on a currently registered PLMN based on the currently registered PLMN of the terminal device and a network selection policy.

In a specific implementation, if the currently registered PLMN has a binding, relationship with the application, or the application is not a forbidden application under the currently registered PLMN, then the terminal device determines to permit date of the application to be bound to the currently registered PLMN.

A processing flow of a network selection method applied to a network device provided by an embodiment of the present disclosure, as shown in FIG. 12, includes:

step S401: sending, by a network device, a network selection policy and/or a binding policy between an application and a USIM to a terminal device.

In an embodiment of the present disclosure, the network selection policy includes a correspondence relationship between an application and a PLMN, and is used by the terminal device to select a PLMN for registering, or the network selection policy is used by the terminal device to decide whether to permit data of an application to be transmitted on a registered PLMN of the terminal device; the correspondence relationship between the application and the PLMN is also referred to as a binding relationship between the application and the PLMN.

It should be noted that in an embodiment of the present disclosure, description for the network selection policy is the same as that in the above step S201, and description for an application and a USIM is the same as those in the above step S301, which will not be repeated herein.

Registration in each embodiment of the present disclosure includes registration or resident; when resident refers to that the terminal device can receive a system broadcast and paging message of a cell, as well as can initiate a RRC connection establishment, but the terminal device has not yet initiated a registration request or a RRC connection to the PLMN.

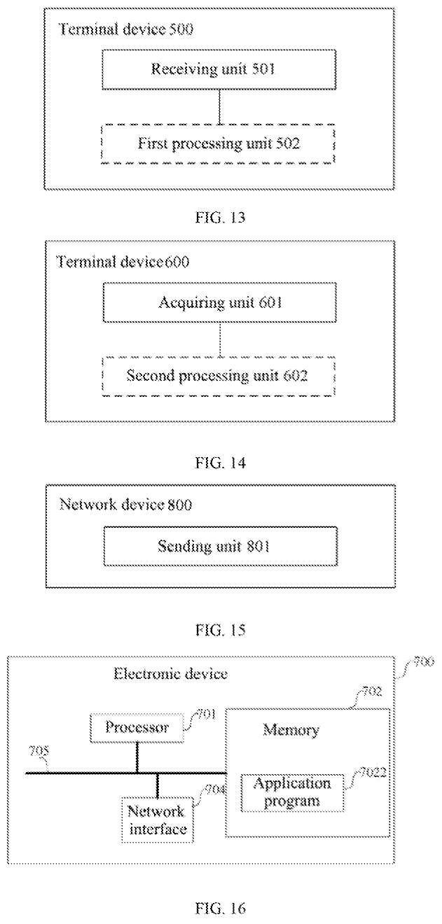

To implement the above network selection method, an embodiment of the present disclosure provides a terminal device, a composition structure of the terminal device 500, as shown in FIG. 13, includes:

a receiving unit 501, configured to receive a network selection policy, where the network selection policy includes a correspondence relationship between an application and a PLMN;

a first processing unit 502, configured to select and perform at least one of the following operations according to the network selection policy:

selecting a PLMN for binding to an application, deciding whether to permit data of an application to be transmitted on a registered PLMN of the terminal device, and selecting PLMN for registering.

In an embodiment of the present disclosure, under the circumstance that content of the network selection policy is the same as a forbidden PLMN, the forbidden PLMN is not selected for binding to an application.

In an embodiment of the present disclosure, when content of the network selection policy is an equivalent PLMN of a currently registered PLMN of the terminal device, the currently registered PLMN is selected for binding to an application.

In an embodiment of the present disclosure, when content of the network selection policy is that a PLMN corresponding to an application belongs to one PLMN within a registration area of the terminal device, and another PLMN within the registration area is a currently registered PLMN of the terminal device, the currently registered PLMN is selected for binding to the application.

In an embodiment of the present disclosure, the correspondence relationship between the application and the PLMN includes:

a correspondence relationship between an application and one PLMN, or correspondence relationships between an application and at least two PLMNs.

In an embodiment of the present disclosure, the correspondence relationship between an application and a PLMN in the network selection policy has a priority order.

In an embodiment of the present disclosure, under the circumstance that the network selection policy includes correspondence relationships between an application and at least two PLMNs, the at least two PLMNs have a priority order.

In an embodiment of the present disclosure, where under the circumstance that the network selection policy further includes: correspondence relationships between an application and at least two PLMNs, and the at least two PLMNs do not have a priority order, one of the at least two PLMNs is selected for registering and binding to the application.

In an embodiment of the present disclosure, the network selection policy further includes: selecting an available PLMN for registering under the circumstance that none of PLMNs corresponding to an application is available.

In an embodiment of the present disclosure, the available PLMN is a registered PLMN of the terminal device.

In an embodiment of the present disclosure, the correspondence relationship between the application and the PLMN includes:

a correspondence relationship of at least one application forbidden to use under different PLMNs; and/or a correspondence relationship of at least one application permitted to use under different PLMNs.

In an embodiment of the present disclosure, the first processing unit 502 is configured to evaluate whether application binding relationships corresponding to different PLMNs in the network selection policy are feasible according to a priority order of the PLMNs.

In an embodiment of the present disclosure, the first processing unit is configured to bind different applications to different USIMs under the circumstance that the terminal device uses multiple USIMs.

In an embodiment of the present disclosure, the first processing unit 502 is configured to bind different applications to different USIMs under the circumstance that the terminal device uses multiple universal subscriber identity modules USIMs.

In an embodiment of the present disclosure, the first processing unit 502 is configured to select one PLMN for binding to an application based on a priority order of running applications under the circumstance that the terminal device uses multiple USIMs.

In an embodiment of the present disclosure, the first processing unit 502 is configured to determine whether to permit data of an application to be transmitted on a currently registered PLMN based on the currently registered PLMN of the terminal device and the network selection policy under the circumstance that the terminal device uses a single USIM.

In an embodiment of the present disclosure, the network selection policy is transferred by a PCF entity to an AMF entity through a container, and then is sent by the AMF entity to the terminal device through a NAS message.

To implement the above network selection method, an embodiment of the present disclosure provides another terminal device, a composition structure of the terminal device 600, as shown in FIG. 14, includes:

an acquiring unit 601, configured to acquire a binding policy between an application and a USIM;

a second processing unit 602, configured to bind different applications to different USIMs based on the binding policy between the application and the USIM.

In an embodiment of the present disclosure, the second processing unit 602 is configured to determine binding relationships between applications and USIMs according to PLMNs corresponding respectively to networks registered by multiple USIMs and a network selection policy;

The network selection policy includes a correspondence relationship between an application and a PLMN.

In an embodiment of the present disclosure, the second processing unit 602 is further configured to select one PLMN for registering based on a priority order of running applications.

In an embodiment of the present disclosure, the second processing unit 602 is further configured to determine whether to permit data of an application to be transmitted on a currently registered PLMN based on the currently registered PLMN of the terminal device and the network selection policy; the network selection policy includes a correspondence relationship between an application and a PLMN.

To implement the above network selection method, an embodiment of the present disclosure provides a network device, a composition structure of the network device 800, as shown in FIG. 15, includes:

a sending unit 801, configured to send a network selection policy and/or a binding policy between an application and a USIM to a terminal device; the network selection policy includes a correspondence relationship between an application and a PLMN, and is used by the terminal device to perform at least one of the following operations:

selecting a PLMN for registering, deciding whether to permit data of an application to be transmitted on a registered PLMN of the terminal device, and selecting a PLMN for binding to an application.

In an embodiment of the present disclosure, under the circumstance that content of the network selection policy is that a PLMN corresponding to an application is the same as a forbidden PLMN, the forbidden PLMN is not selected for binding to the application;

and/or, when content of the network selection policy is that a PLMN corresponding to an application is an equivalent PLMN of a currently registered PLMN of the terminal device, the currently registered PLMN is selected for binding to the application;

and/or, when content of the network selection policy is that a PLMN corresponding to an application belongs to one PLMN within a registration area of the terminal device, and another PLMN within the registration area is a currently registered PLMN of the terminal device, the currently registered PLMN is selected for binding to the application.

In an embodiment of the present disclosure, the correspondence relationship between the application and the PLMN includes:

a correspondence relationship between an application and one PLMN, or correspondence relationships between an application and at least two PLMNs.

In an embodiment of the present disclosure, the correspondence relationship between the application and the PLMN in the network selection policy has a priority order.

In an embodiment of the present disclosure, under the circumstance that the network selection policy includes correspondence relationships between an application and at least two PLMNs, the at least two PLMNs have a priority order.

In an embodiment of the present disclosure, under the circumstance that the network selection policy includes correspondence relationships between an application and at least two PLMNs, and the at least two PLMNs do not have a priority order, one PLMN of the at least two PLMNs is selected for binding to the application.

In an embodiment of the present disclosure, the network selection policy further includes:

selecting an available PLMN for binding to an application under the circumstance that none of PLMNs corresponding to the application is available.

In an embodiment of the present disclosure, the available PLMN is a registered PLMN of the terminal device.

In an embodiment of the present disclosure, the correspondence relationship between the application and the PLMN includes:

a correspondence relationship of at least one application forbidden to use under different PLMNs; and/or a correspondence relationship of at least one application permitted to use under different PLMNs.

In an embodiment of the present disclosure, a priority order of the PLMNs is used by the terminal device to evaluate whether application binding relationships corresponding, to different PLMNs in the network selection policy are feasible.

In an embodiment of the present disclosure, the binding policy between the application and the USIM includes:

binding different applications to different USIMs under the circumstance that the terminal device uses multiple USIMs.

In an embodiment of the present disclosure, the binding policy between the application and the USIM includes:

determining binding relationships between applications and USIMs according to PLMNs corresponding respectively to networks registered by multiple USIMs and the network selection policy.

In an embodiment of the present disclosure, the binding policy between the application and the USIM includes:

a priority order of running applications, which is used by the terminal device to select one PLMN for registering.

In an embodiment of the present disclosure, the network selection policy is transferred by a PCF entity to an AMF entity through a container, and then is sent by the AMP entity to the terminal device through a NAS message.

An embodiment of the present disclosure also provides a terminal device, including a processor and a memory for storing a computer program being executable on the processor, where the processor, when executing the computer program, is configured to perform steps of the above network selection method performed by the terminal device.

An embodiment of the present disclosure also provides a network device, including a processor and a memory for storing a computer program being executable on the processor, where the processor, when executing the computer program, is configured to perform steps of the above network selection method performed by the network device.

FIG. 16 is a schematic diagram of a hardware composition structure of an electronic device (a terminal device and a network device) according to an embodiment of the present disclosure, and the electronic device 700 includes: at least one processor 701, a memory 702, and at least one network interlace 704. Various components in the electronic device 700 are coupled together through a bus system 705. It can be understood that the bus system 705 is used to implement connection and communication between these components. In addition to a data bus, the bus system 705 also includes a power bus, a control bus, and a state signal bus. However, for the sake of clear description, various buses are marked as the bus system 705 in FIG. 16.

It can be understood that the memory 702 may be a volatile memory or a non-volatile memory, and may also include both a volatile memory and a non-volatile memory. The non-volatile memory may be a ROM, a programmable read-only memory (PROM), an erasable programmable read-only memory (EPROM), an electrically erasable programmable read-only memory (EEPROM), a ferromagnetic random access memory (FRAM), a flash memory, a magnetic surface memory, an optical disk, or a compact disc read-only memory (CD-ROM); the magnetic surface memory may be a disk memory or a tape memory. The volatile memory may be a random access memory (RAM), which is used as an external cache. By way of exemplary but not restrictive description, many forms of RAMs are available, such as a static random access memory (SRAM), a synchronous static random access memory (SSRAM), a dynamic random access Memory (DRAM), a synchronous dynamic random access memory (SDRAM), a double data rate synchronous dynamic random access memory (DDRSDRAM), an enhanced synchronous dynamic random access memory (ESDRAM), a synclink dynamic random access memory (SLDRAM), and a direct nimbus random access memory (DRRAM). The memory 702 described in the embodiment of the present disclosure is intended to include, but is not limited to, these and any other suitable types of memories.

The memory 702 in the embodiment of the present disclosure is used to store various types of data to support operations of the electronic device 700. Examples of such data include: any computer program used to be executed on the electronic device 700, such as an application program 7022. A program for implementing the method of the embodiment of the present disclosure may be included in the application program 7022.

The method disclosed in the above embodiment of the present disclosure may be applied to the processor 701, or implemented by the processor 701. The processor 701 may be an integrated circuit chip with signal processing capabilities. In an implementation process, each step of the above method may be completed by an integrated logic circuit of hardware or instructions in a form of software in the processor 701. The above processor 701 may be a general-purpose processor, a digital signal processor (DSP), or other programmable logic devices, discrete gates or transistor logic devices, discrete hardware components, etc. The processor 701 may implement or execute various methods, steps, and logical block diagrams disclosed in embodiments of the present disclosure. The general-purpose processor may be a microprocessor or any conventional processor, etc. Steps of the method disclosed in conjunction with embodiments of the present disclosure may be directly embodied as being executed and completed by a hardware decoding processor, or be executed and completed by a combination of hardware and software modules in the decoding processor. The software module may be located in a storage medium, and the storage medium is located in the memory 702, the processor 701 reads information in the memory 702 and completes steps of the foregoing method in conjunction with its hardware.

In an exemplary embodiment, the electronic device 700 may be implemented by one or more application specific integrated circuits (ASIC), DSPs, programmable logic devices (PLD), complex programmable logic devices (CPLD), FPGAs, general-purpose processors, controllers, MCUs, MPUs, or other electronic elements, to perform the foregoing method.

An embodiment of the present application also provides a storage medium for storing a computer program.

In an implementation, the storage medium may be applied to the terminal device in the embodiment of the present application, and the computer program causes a computer to execute corresponding flows in each method of embodiments of the present application. For brevity, details are not described herein again.

In an implementation, the storage medium may be applied to the network device in the embodiment of the present application, and the computer program causes a computer to execute corresponding flows in each method of the embodiments of the present application. For brevity, details are not described herein again.

The present disclosure is described with reference to flowcharts and/or block diagrams of methods, devices (systems), and computer program products according to embodiments of the present disclosure. It should be understood that each flow and/or block in the flowcharts and/or the block diagrams, and a combination of flows and/or blocks in the flowcharts and/or the block diagrams may be implemented by computer program instructions. These computer program instructions may be provided to a processor of a general-purpose computer, a special-purpose computer, an embedded processor, or other programmable data processing devices, to generate a machine, so that instructions executed by processor of the computer or other programmable data processing devices produce an apparatus used to implement functions specified in one flow or multiple flows in the flowcharts and/or in one block or multiple blocks in the block diagrams.

These computer program instructions may also be stored in a computer readable memory that can direct a computer or other programmable data processing devices to work in a specific manner, so that the instructions stored in the computer readable memory produce an article of manufacture including the instruction apparatus, the instruction apparatus implements functions specified in one flow or multiple flows in the flowcharts and/or one block or multiple blocks in the block diagrams.

These computer program instructions may also be loaded to a computer or other programmable data processing devices, so that a series of operation steps are executed on the computer or other programmable devices to produce a computer implemented processing, and thus the instructions executed on the computer or other programmable devices provide steps for implementing functions specified in one flow or multiple flows in the flowcharts and/or one block or multiple blocks in the block diagrams.

The above are merely preferred embodiments of the present disclosure, and are not used to limit the protection scope of the present disclosure, any modification, equivalent replacement and improvement, etc., made within the spirit and the principle of the present disclosure shall be included within the protection scope of the present disclosure.

What is claimed is:

1. A network selection method, the method comprising:
receiving, by a terminal device, a network selection policy, wherein the network selection policy comprises a correspondence relationship between an application and a public land mobile network (PLMN);
performing, by the terminal device, at least one of the following operations according to the network selection policy;
selecting a PLMN for binding to an application;
deciding whether to permit data of an application to be transmitted on a registered PLMN of the terminal device;
selecting a PLMN for registering.

2. The method according to claim 1, wherein
under the circumstance that content of the network selection policy is that a PLMN corresponding to an application is the same as a forbidden PLMN, the forbidden PLMN is not selected for binding to the application.

3. The method according to claim 1, wherein when content of the network selection policy is that a PLMN corresponding to an application is an equivalent PLMN of a currently registered PLMN of the terminal device, the currently registered PLMN is selected for binding to the application.

4. The method according to claim 1, wherein when content of the network selection policy is that a PLMN corresponding to an application belongs to one PLMN within a registration area of the terminal device, and another PLMN within the registration area is a currently registered PLMN of the terminal device, the currently registered PLMN is selected for binding to the application.

5. The method according to claim 1, wherein the correspondence relationship between the application and the PLMN comprises:
a correspondence relationship between an application and one PLMN;
or, correspondence relationships between an application and at least two PLMNs.

6. The method according to claim 1, wherein the correspondence relationship between the application and the PLMN in the network selection policy has a priority order.

7. The method according to claim 1, wherein under the circumstance that the network selection policy comprises correspondence relationships between an application and at least two PLMNs, the at least two PLMNs have a priority order.

8. The method according to claim 1, wherein under the circumstance that the network selection policy further comprises: correspondence relationships between an application and at least two PLMNs, and the at least two PLMNs do not have a priority order, one PLMN of the at least two PLMNs is selected for binding to the application.

9. The method according to claim 1, wherein the network selection policy further comprises:
selecting an available PLMN for binding to an application under the circumstance that none of PLMNs corresponding to the application is available.

10. The method according to claim 9, wherein the available PLMN is a registered PLMN of the terminal device.

11. The method according to claim 1, wherein the correspondence relationship between the application and the PLMN comprises:
a correspondence relationship of at least one application forbidden to use under different PLMNs;
and/or, a correspondence relationship of at least one application permitted to use under different PLMNs.

12. The method according to claim 11, wherein the terminal device evaluates whether application binding relationships corresponding to different PLMNs in the network selection policy are feasible according to a priority order of the PLMNs.

13. The method according to claim 11, further comprising binding, by the terminal device, different applications to different universal subscriber identity modules (USIMs) under the circumstance that the terminal device uses multiple USIMs.

14. The method according to claim 13, wherein the binding, by the terminal device, different applications to different USIMs comprises:
determining, by the terminal device, binding relationships between applications and USIMs according to PLMNs corresponding respectively to networks registered by multiple USIMs and the network selection policy.

15. The method according to claim 1, wherein under the circumstance that the terminal device uses multiple USIMs, the selecting, by the terminal device, a PLMN for binding to an application according to the network selection policy comprises:
selecting, by the terminal device, one PLMN for binding to an application based on a priority order of running applications.

16. The method according to claim 1, wherein under the circumstance that the terminal device uses a single USIM, the deciding, by the terminal device, whether to permit data of an application to be transmitted on a currently registered PLMN of the terminal device according to the net work selection policy comprises:
determining, by the terminal device, whether to permit data of an application to be transmitted on the currently registered PLMN based on the currently registered PLMN of the terminal device and the network selection policy.

17. The method according to claim 1, wherein the network selection policy is transferred by a policy control function (PCF) entity to an access and mobility management function (AMF) entity through a container, and then is sent by the AMF entity to the terminal device through a non-access stratum (NAS) message.

18. A network selection method, the method comprising:
sending, by a network device, a network selection policy and/or a binding policy between an application and a universal subscriber identity module (USIM) to a terminal device; wherein the network selection policy comprises a correspondence relationship between an application and a public land mobile network (PLMN), and is used by the terminal device to perform at least one of the following operations:
selecting a PLMN fur binding to an application;
deciding whether to permit data of an application to be transmitted on a registered PLMN of the terminal device;
selecting a PLMN for registering.

19. The method according to claim 18, wherein
under the circumstance that content of the network selection policy is that a PLMN corresponding to an application is the same as a forbidden PLMN, the forbidden PLMN is not selected for binding to the application;
and/or, when content of the network selection policy is that a PLMN corresponding to an application is an equivalent PLMN of a currently registered PLMN of the terminal device, the currently registered PLMN is selected for binding to the application;
and/or, when content of the network selection policy is that a PLMN corresponding to an application belongs to one PLMN within a registration area of the terminal device, and another PLMN within the registration area is a currently registered PLMN of the terminal device, the currently registered PLMN is selected for binding to the application.

20. A terminal device, the terminal device comprising a processor and a memory for storing a computer program being executable on the processor, wherein the processor, when executing the computer program, is configured to:
control a network interface to receive a network selection policy, wherein the network selection policy comprises a correspondence relationship between an application and a public land mobile network (PLMN);
perform at least one of the following operations according to the network selection policy;
selecting a PLMN for binding to an application;
deciding whether to permit data of an application to be transmitted on a registered PLMN of the terminal device;
selecting a PLMN for registering.
